(19) United States
(12) Patent Application Publication
(10) Pub. No.: US 2013/0192402 A1
(43) Pub. Date: Aug. 1, 2013

(54) DRIVING APPARATUS, GEAR MEMBER, AND ELECTRONIC DEVICE

(71) Applicant: KYOCERA DOCUMENT SOLUTIONS INC., Osaka (JP)

(72) Inventor: Masahiko MIZUNO, Osaka (JP)

(73) Assignee: KYOCERA DOCUMENT SOLUTIONS INC., Osaka (JP)

(21) Appl. No.: 13/747,198

(22) Filed: Jan. 22, 2013

(30) Foreign Application Priority Data
Jan. 27, 2012 (JP) 2012-015340

(51) Int. Cl. F16H 55/17

(52) U.S. Cl. CPC F16H 55/17
USPC 74/434

(57) ABSTRACT

A driving apparatus includes a rotary member and a gear member. The rotary member rotates about an axis of its own. The gear member includes an inner peripheral surface which forms a space corresponding to a shape of the rotary member and an outer peripheral surface on which gear teeth are formed. The gear member is fitted to the rotary member by press fit. The outer peripheral surface includes, in a direction of an axis of rotation of the gear member, a toothed region in which the gear teeth are formed and a non-toothed region in which no gear teeth are formed.

### INCORPORATION BY REFERENCE

The present application claims priority under 35 U.S.C. §119 to Japanese Patent Application No. 2012-015340, filed Jan. 27, 2012. The contents of this application are incorporated herein by reference in their entirety.

### BACKGROUND

The present disclosure relates to driving apparatuses, gear members, and electronic devices.

Electronic devices, such as copiers, printers, fax machines, multi-functional products thereof, etc. include a variety of rotors. Examples of the rotors include photosensitive drums, development rollers, fixing rollers, sheet conveyance rollers, etc. Driving power generated by a driving source, such as a motor is transmitted to these rotors through power transmission mechanisms, such as a reduction gear, an idle gear, etc., thereby rotating and driving the rotors.

A power transmission mechanism generally includes a motor gear directly connected to an output shaft of a motor and a driven gear directly connected to a rotary shaft of a rotor. The motor gear is formed of a cylindrical member having an inner peripheral surface, which is inserted to the output shaft of the motor, and an outer peripheral surface on which gear teeth are formed. The inner diameter of the inner peripheral surface of the motor gear is set slightly smaller than the outer diameter of the output shaft of the motor. The motor gear is press fitted into the output shaft, thereby fixing the motor gear to the output shaft.

The present disclosure provides, in a driving apparatus with a structure in which a gear member is press fitted to a rotary member, such as an output shaft of a motor, a device that can reduce adverse influence on the shape of gear teeth in press fit.

### SUMMARY

A driving apparatus according to one aspect of the present disclosure includes a rotary member and a gear member. The rotary member rotates about an axis of its own. The gear member includes an inner peripheral surface which forms a space corresponding to a shape of the rotary member and an outer peripheral surface on which gear teeth are formed. The gear member is fitted to the rotary member by press fit. The outer peripheral surface includes, in a direction of an axis of rotation of the gear member, a toothed region in which the gear teeth are formed and a non-toothed region in which no gear teeth are formed. The inner peripheral surface includes, in the direction of the axis of rotation of the gear member, a non-press fit region with an inner diameter having a size that requires no press fitting of the gear member and a press fit region with an inner diameter having a size that requires the press fitting of the gear member. At least part of the non-press fit region lies within a region corresponding to the toothed region, while the press fit region lies within a region corresponding to the non-toothed region.

A gear member according to one aspect of the present disclosure includes an inner peripheral surface and an outer peripheral surface. The gear member is fitted to a rotary member that rotates about an axis of its own by press fit. The outer peripheral surface includes, in a direction of an axis of rotation of the gear member, a toothed region in which the gear teeth are formed and a non-toothed region in which no gear teeth are formed. The inner peripheral surface includes, in the direction of the axis of rotation of the gear member, a non-press fit region with an inner diameter having a size that requires no press fitting of the gear member and a press fit region with an inner diameter having a size that requires the press fitting of the gear member. At least part of the non-press fit region lies within a region corresponding to the toothed region, while the press fit region lies within a region corresponding to the non-toothed region.

An electronic device according to one aspect of the present disclosure includes a driving apparatus. The driving apparatus includes a rotary member and a gear member. The rotary member rotates about an axis of its own. The gear member includes an inner peripheral surface which forms a space corresponding to a shape of the rotary member and an outer peripheral surface on which gear teeth are formed. The gear member is fitted to the rotary member by press fit. The outer peripheral surface includes, in a direction of an axis of rotation of the gear member, a toothed region in which the gear teeth are formed and a non-toothed region in which no gear teeth are formed. The inner peripheral surface includes, in the direction of the axis of rotation of the gear member, a non-press fit region with an inner diameter having a size that requires no press fi of the gear member and a press fit region with an inner diameter having a size that requires the press fitting of the gear member. At least part of the non-press fit region lies within a region corresponding to the toothed region, while the press fit region lies within a region corresponding to the non-toothed region.

### BRIEF DESCRIPTION OF THE DRAWINGS

FIG. 1 is an external perspective view of a driving apparatus according to one embodiment of the present disclosure.

FIG. 2 is a schematic diagram showing one example of the driving apparatus in use.

FIG. 3 is a perspective view of a gear member included in the driving apparatus.

FIG. 4 is a cross sectional view of the gear member.

FIG. 5 is a cross sectional view of the driving apparatus.

FIG. 6 is an enlarged cross sectional view of the main part in FIG. 5.

FIG. 7 is a cross sectional view of a driving apparatus.

FIG. 8 is an enlarged cross sectional view of the main part of a driving apparatus according to the first modified embodiment.

FIG. 9 is a cross sectional view of a driving apparatus according to the second modified embodiment.

FIG. 10 is a top view of a driving apparatus according to the third modified embodiment.

FIG. 11 is an illustration showing a schematic configuration of an image forming device including a driving apparatus S.

### DETAILED DESCRIPTION

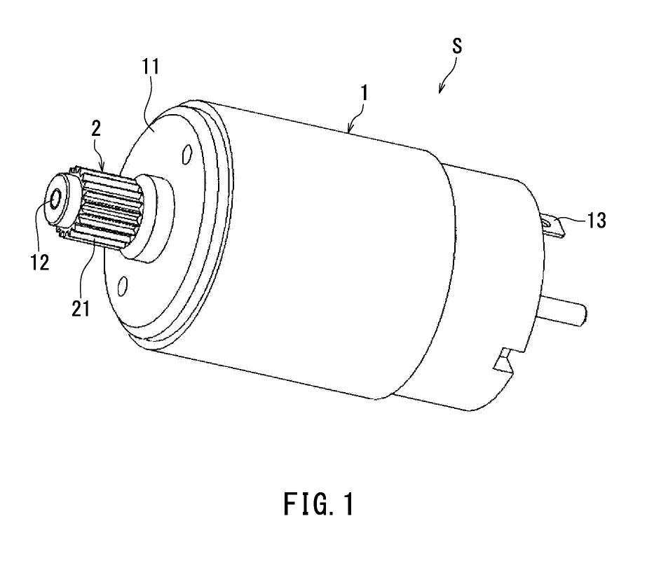

Embodiments of the present disclosure will be described below with reference to the accompanying drawings. FIG. 1 is an external perspective view of a driving apparatus S according to one embodiment of the present disclosure. The driving apparatus S includes a motor 1 that generates rotational force and a gear member 2 driven by the motor 1.

The motor 1 is a stepping motor that includes a rotor and a stator and is operated by receiving pulse power. An output shaft 12 (rotary member) integral with the rotor protrudes from one end surface 11 of a columnar motor main body. Further, a terminal 13 that supplies the pulse power to a stator wire is provided at the other end surface of the motor main body. When the pulse power is provided to the terminal 13, the output shaft 12 rotates about an axis of its own. It is noted that the motor 1 may be any motor other than the stepping motor, such as a DC motor or the like, for example.

The gear member 2 is directly connected to the output shaft 12 and includes gear teeth 21 as a spur gear. The gear member 2 is a cylindrical member having an inner peripheral surface, in which the output shaft 12 of the motor 1 is inserted (press fitted), and an outer peripheral surface on which the gear teeth 21 are formed. FIG. 1 shows the state where the gear member 2 is inserted at the proper position to the output shaft 12. It is noted that the output shaft 12 is a metal member, while the gear member 2 is formed of a resin molded article. The gear member 2 is in mesh with another spur gear as a to-be-driven target.

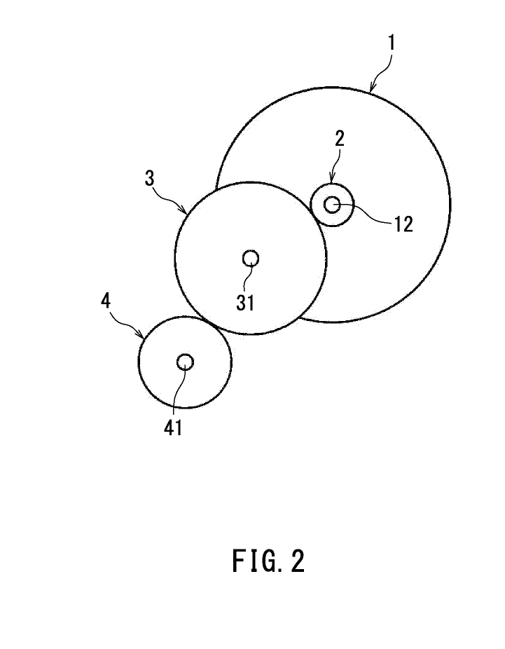

FIG. 2 is a schematic diagram showing one example of the driving apparatus S in use. FIG. 2 shows an example where a gear array of a reduction gear 3 and a driven gear 4 is driven by the gear member 2. The reduction gear 3 is a gear configured to freely rotate about the axis of a rotary shaft 31 and has gear teeth in mesh with the gear teeth 21 of the gear member 2 on its peripheral surface. The driven gear 4 is a gear integrally mounted on a rotary shaft 41 of a rotor (not shown) as a to-be-driven target and is in mesh with the reduction gear 3. For example, in the case where the driving apparatus S is applied to an image forming device, the rotor may be a photosensitive dram, a development roller, a fixing roller, a sheet conveyance roller, or the like. When the motor 1 is driven, the output shaft 12 and the gear member 2 are rotated, so that their rotational force is transmitted to the rotary shaft 41 through the reduction gear 3 and the driven gear 4, thereby driving and rotating the rotor.

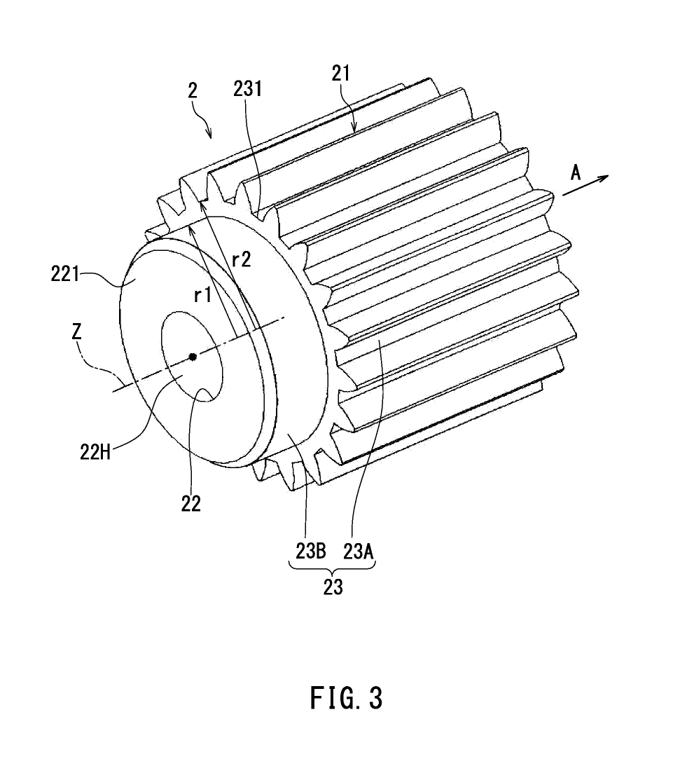

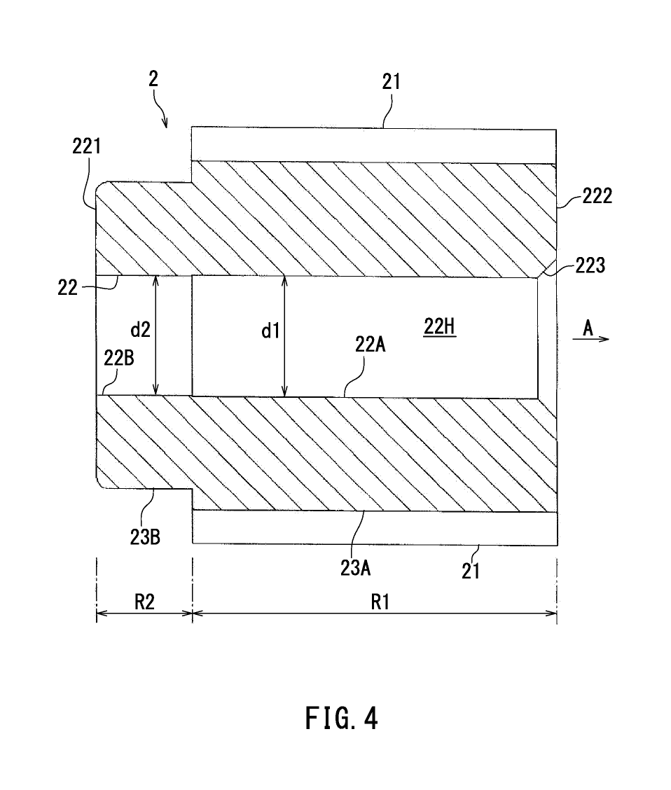

The configuration of the gear member 2 will be described next in detail. FIG. 3 is a perspective view of the gear member 2. FIG. 4 is a cross sectional view of the gear member 2 taken along the central axis Z of the gear member 2 (axis of rotation of the gear member). The gear member 2 is a cylindrical member with a columnar through hole 22H (columnar space) coaxial with the central axis Z and corresponding to the shape of the output shaft 12. That is, the gear member 2 has a cylindrical inner peripheral surface 22 that forms the through hole 22H and an outer peripheral surface 23 that is located at the outer periphery thereof. The gear member 2 is fitted to the output shaft 12 by inserting (press fitting) the output shaft 12 of the motor 1 into the through hole 22H. It is noted that the direction indicated by the arrows A in FIGS. 3 and 4 is the direction where the gear member 2 is inserted to the output shaft 12 (hereinafter referred to as insertion direction A).

The outer peripheral surface 23 includes, in the direction in which the central axis Z of the gear member 2 extends, a toothed region 23A in which the gear teeth 21 are formed and a non-toothed region 23B in which no gear teeth 21 are formed. The non-toothed region 23B is arranged on the side of a first end surface 221 (second flat surface) located at an end on the rear end side in the insertion direction A of the gear member 2 (end opposite to the end on the side where the gear member is inserted to the rotary member). The toothed region 23A is arranged on the side of a second end surface 222 located on the front end side in the insertion direction A of the gear member 2. Each of the first end surface 221 and the second end surface 222 is a flat surface perpendicular to the central axis Z. It is noted that in order to facilitate insertion of the gear member 2 to the output shaft 12, part of the inner peripheral surface 22 in the vicinity of the second end surface 222 forms a tapered surface 223 of which inner diameter increases.

Referring to the toothed region 23A, the plurality of gear teeth 21 extending in parallel to the central axis Z are formed at a regular pitch in the peripheral direction of the outer peripheral surface 23. The non-toothed region 23B is a plain peripheral surface. The radius r1 of the non-toothed region 23B is set smaller than the radius r2 of a root circle 231 of the toothed region 23A. That is, the diameter of the peripheral surface of the non-toothed region 23b is smaller than the diameter of the root circle 231 of the toothed region 23A. Since setting r1<r2 can prevent the non-toothed region 23B from protruding outward in the radial direction from the root circle 231 of the toothed region 23A, the degree of freedom can be increased in a meshing state of another gear member with the gear member 2 or in assembly.

Although a length ratio between the toothed region 23A and the non-toothed region 23B in the direction of the central axis Z is not limited specifically, the length ratio between the toothed region 23A and the non-toothed region 23B may be selected from the range between 4:1 and 5:1, for example. Where the length of the toothed region 23A is long to some extent, limitations on the meshing state with another gear member are less imposed, which is preferable. Also, where the non-toothed region 23B is long to some extent, a press fit region, which will be described later, becomes long to tend to increase the holding power of the gear member 2 with respect to the output shaft 12, which is preferable.

Referring to FIG. 4, the inner peripheral surface 22 includes, in the direction in which the central axis Z extends, a non-press fit region R1 and a press fit region R2. At least part of the non-press fit region R1 lies within a region corresponding to the toothed region 23A, while the press fit region R2 lies within a region corresponding to the non-toothed region 23B. In the gear member 2 shown in FIG. 4, the region corresponding to the toothed region 23A agrees with the non-press fi region R1, and the region corresponding to the non-toothed region 23B agrees with the press fit region R2. The non-press fit region R1 is different in inner diameter from the press fit region R2. Specifically, the non-press fit region R1 has a first inner diameter d1 with a size that requires no press fitting of the gear member 2, while the press fit region R2 has a second inner diameter d2 with a size that requires press fitting of the gear member 2. For the purpose of tight insertion, the first inner diameter d1 before the gear member 2 is fitted to the output shaft 12 is set equal to or slightly larger than the outer diameter of the output shaft 12. For example, it is about +0.0% to +0.3% in terms of a ratio of the difference of the inner diameter of the gear member 2 from the outer diameter of the output shaft 12 to the outer diameter of the output shaft 12. On the other hand, the second inner diameter d2 before the gear member 2 is fitted to the output shaft 12 is set slightly smaller than the outer diameter of the output shaft 12. For example, it is about −0.3% to −0.6% in terms of a ratio of the difference of the inner diameter of the gear member 2 from the outer diameter of the output shaft 12 to the outer diameter of the output shaft 12. Accordingly, the second inner diameter d2 is smaller than the first inner diameter d1. It is noted that the second diameter 2d may be set so as to decrease as it goes toward the first end surface 221 in the press fit region R2 to prevent the gear member 2 from falling off from the output shaft 12.

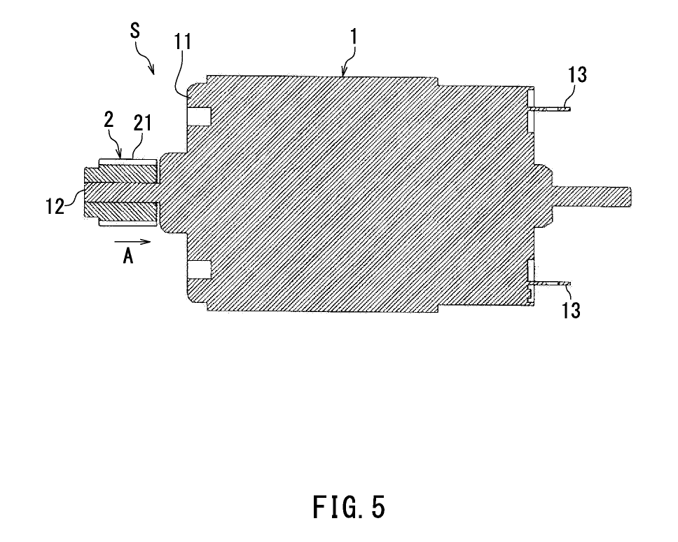

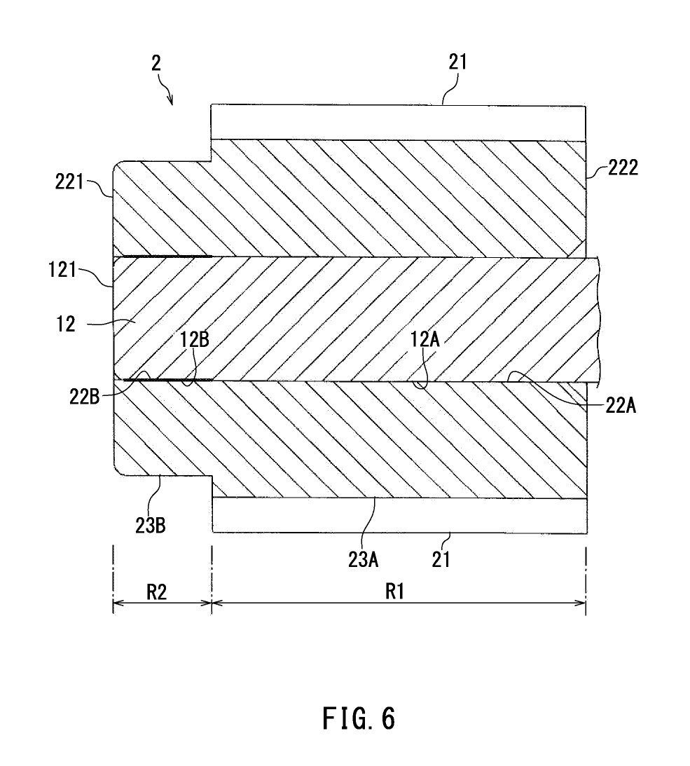

FIG. 5 is a cross sectional view taken along the central axis Z when the gear member 2 is fitted to the output shaft 12 of the motor 1. FIG. 6 is an enlarged cross sectional view of the main part in FIG. 5. When the gear member 2 is inserted to the output shaft 12, an inner peripheral surface 22B corresponding to the press fit region R2 of the gear member 2, which has the aforementioned second inner diameter d2, is press fitted to the output shaft 12. In other words, the inner peripheral surface 22B is in press contact with the outer peripheral surface 12B of the output shaft 12 to serve as a fixing part. On the other hand, an inner peripheral surface 22A corresponding to the non-press fit region R1, which has the aforementioned first inner diameter d1, is not in a press fitting state but is in contact with or close to the outer peripheral surface 12A of the output shaft 12 with no backlash against the output shaft 12 caused (with no significant gap formed).

Thus, it is only the inner peripheral surface 22B corresponding to the press fit region R2 in the inner peripheral surface 22 of the gear member 2 that serves as a region that is press fitted to the output shaft 12. The press fit region R2 is a region corresponding to the non-toothed region 23B where no gear teeth 21 are formed. Accompanied by fitting of the gear member 2 to the output shaft 12, press fitting partially increases the diameter of the gear member 2 in the press fit region R2, while no increase in diameter is caused in the non-press fit region R1. Thus, no adverse influence is caused on the gear teeth 21 formed in the toothed region 23A in the region corresponding to the non-press fit region R1. In other words, such a diameter increase may not bring deformation of the shape of the gear teeth 21.

A dedicated jig with a pressure flap is used for fitting the gear member 2 to the output shaft 12. An operator sets the second end surface 222 of the gear member 2 so as to face a distal end surface 121 of the output shaft 12 (end on the side where the gear member is inserted) and sets the tapered surface 223 along the distal end surface 121. Then, the pressure flap of the jig is disposed on the side of the first end surface 221, and pressing force in the insertion direction A is applied thereto. This inserts (press fits) the output shaft 12 into the inner peripheral surface 22 (the through hole 22H) of the gear member 2. When the gear member 2 is inserted up to the proper position of the output shaft 12, the operator stops the operation of the pressure flap. In fitting the gear member 2 to the output shaft 12, the non-press fitting state changes to the press fitting state.

In the present embodiment, the distal end surface 121 of the output shaft 12 is a flat surface (first flat surface) perpendicular to the central axis Z. Further, the proper position is defined such that the first end surface 221 of the gear member 2 is aligned with the distal end surface 121. Accordingly, the operator checks that the first end surface 221 is aligned with the distal end surface 121, while inserting the gear member 2 in the insertion direction A. Checking the alignment of the surfaces can result in checking proper insertion of the gear member 2 to the output shaft 12. This can easily and reliably prevent variation in insertion of the gear member 2.

In the present embodiment, the toothed region 23A is arranged on the front end side in the insertion direction A of the gear member 2, while the non-toothed region 23B is arranged on the rear end side in the insertion direction A thereof. Accordingly, the press fit region R2 where the gear member 2 is press fitted is disposed on the rear end side in the insertion direction A of the gear member 2. As such, it is only the final stage of the insertion of the gear member 2 to the output shaft 12 that requires a load for press fit. This means that a time period when a load of the pressure flap of the jig is required can be minimized Thus, workability can be increased in insertion of the gear member 2.

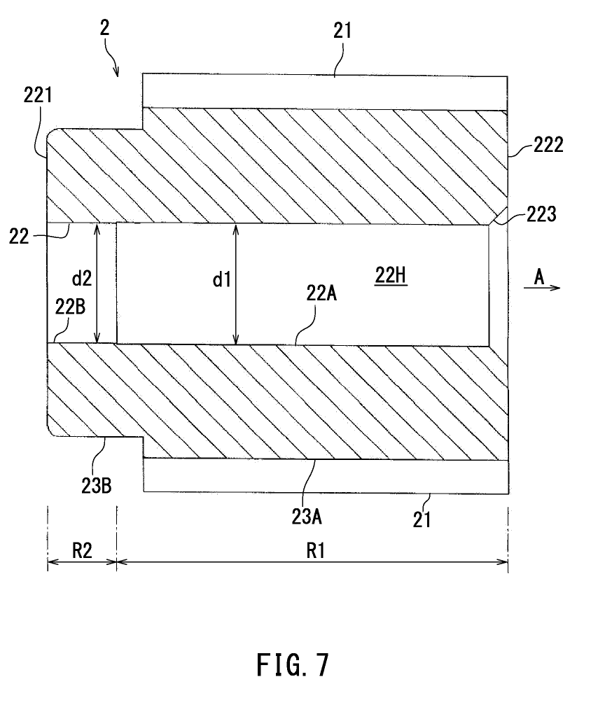

It is noted that in the gear member 2 in FIG. 4, the region corresponding to the toothed region 23A agrees with the non-press fit region R1, and the region corresponding to the non-toothed region 23B agrees with the press fit region R2. However, the region corresponding to the non-toothed region 23B may be a combination of the non-press fit region R1 and the press fit region R2. FIG. 7 is a cross sectional view of a gear member 2 according to the first embodiment taken along the central axis Z (axis of rotation of the gear member). In the gear member 2 in FIG. 7, the toothed region 23A is the non-press fit region R1 only, while the non-press fit region R1 and the press fit region R2 are present in combination in the non-toothed region 23B.

According to the driving apparatus S of the present embodiment, which has the configuration in which the gear member 2 is press fitted to the output shaft 12 of the motor 1, the shape of the gear teeth 21 may hardly be deformed even in press fit. Thus, when the power is transmitted to the other gears 3, 4 in a state, for example, shown in FIG. 2, vibration caused by tooth meshing and the like can be reduced.

One embodiment of the present disclosure has been described in detail. According to the driving apparatus of the present disclosure, which has a configuration in which a gear member is press fitted to a rotary member, such as an output shaft of a motor, the shape of gear teeth may hardly be deformed even in press fit. Thus, the driving apparatus can be provided which can reduce vibration caused by tooth meshing and the like.

It is noted that the present disclosure is not limited to the above configuration. For example, the present disclosure may have any of the configurations in the following modified embodiments.

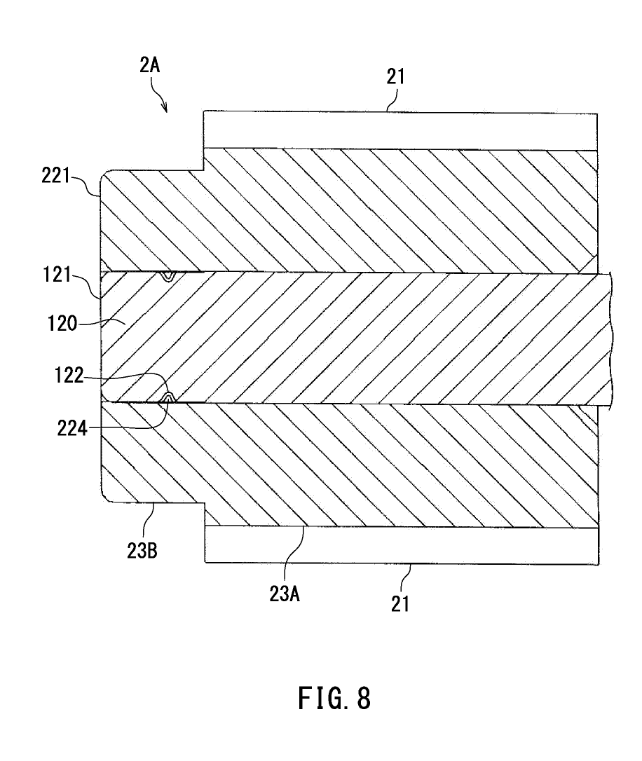

(1) FIG. 8 is an enlarged cross sectional view of the main part of a gear member 2A and an output shaft 120 according to the first modified embodiment. An annular ridge 224 (first engaging portion) protrudes in the press fit region R2 of the inner peripheral surface 22 of the gear member 2A. On the other hand, an annular groove 122 (second engaging portion) configured to receive (engage with) the ridge 224 is formed in the peripheral surface of the output shaft 120. The ridge 224 is fitted in the groove 122 when the gear member 2 is inserted up to the proper portion of the output shaft 120. In other words, when the first end surface 221 of the gear member 2A is aligned with the distal end surface 121 of the output shaft 120, the ridge 224 is fitted in the groove 122.

According to the first modified embodiment, fitting the ridge 224 in the groove 122 can prevent the gear member 2A from falling off from the output shaft 120. Further, when the gear member 2A is inserted up to the proper position of the output shaft 120, fitting of the ridge 224 into the groove 122 makes clicking. With this clicking, the operator can accordingly confirm proper insertion of the gear member 2A.

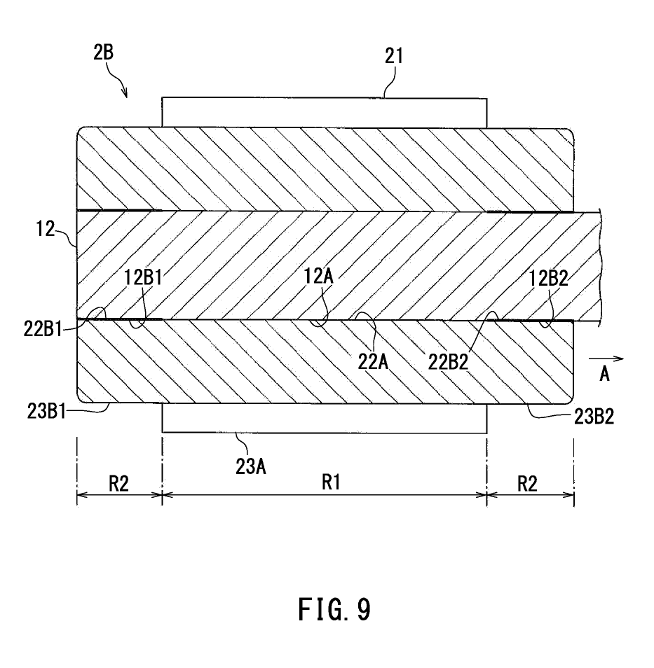

(2) FIG. 9 is a cross sectional view of a gear member 2B according to the second modified embodiment. In the gear member 2B, two non-toothed regions 23B1 and 23B2 are provided on the front end side and the rear end side in the insertion direction A of the gear member 2B, respectively. The toothed region 23A is provided between the front end non-toothed region 23B1 and the rear end non-toothed region 23B2. Similarly to the above embodiment and the first modified embodiment, a non-press fit region R1 corresponding to the toothed region 23A has an inner diameter with a size that can be inserted to the output shaft 12 of the motor 1 tightly in a non-press fitting state. On the other hand, two press fit regions R2 corresponding to the front end and rear end non-toothed regions 23B1, 23B2 each have an inner diameter with a size that can be press fitted to the output shaft 12. When the gear member 2B is press fitted to the output shaft 12, inner peripheral surfaces 22B1, 22B2 corresponding to the two press fit regions R2 are in press contact with outer peripheral surfaces 12B1, 12B2 of the output shaft 12 to serve as fixing parts. On the other hand, an inner peripheral surface 22A corresponding to the non-press fit region R1 is not in a press fitting state, but is in contact with or close to an outer peripheral surface 12A of the output shaft 12 with no backlash against the output shaft 12 caused. It is noted that non-press fitting of the gear member 2B to the output shaft 12 may cause no increase in pressing force. Accordingly, the pressing force may not increase in transition from the press fitting state to the non-press fitting state. In fitting the gear member 2B to the output shaft 12, the press fitting state changes to the non-press fitting state, and then, to the press fitting state.

According to the second modified embodiment, the press fit region R2 where the gear member 2B is press fitted to the output shaft 12 is provided at each of the front end part and the rear end part in the insertion direction A. This can stably achieve prevention of the gear member 2B from falling off from the output shaft 12.

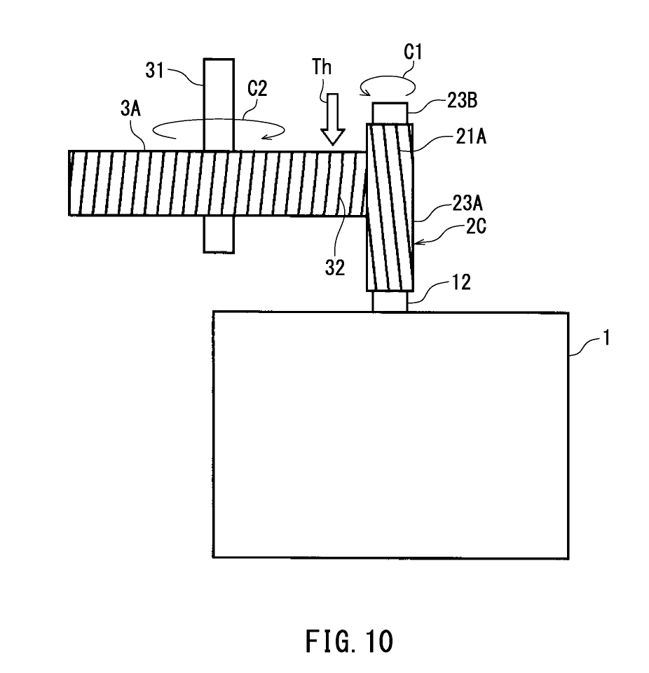

(3) FIG. 10 is a top view of a driving apparatus according to the third modified embodiment. A gear member 2C in the third modified embodiment includes gear teeth 21A as helical teeth in the toothed region 23A. A reduction gear 3A configured to mesh with the gear member 2C also includes gear teeth 32 as helical teeth. The helical directions of the helical gear teeth 21A and 32 and the direction of rotation of the output shaft 12 are selected so that thrust force Th that acts to prevent the gear member 2C from falling off from the output shaft 12 in the axial direction is generated.

In detail, the helical direction of the helical gear teeth 21A of the gear member 2C is left. On the other hand, the helical direction of the gear teeth 32 of the reduction gear 3A is right. Further, as indicated by the arrow in FIG. 10, rotational force that rotates about the axis of the output shaft 12 in the anticlockwise direction C1 is applied to the gear member 2C from the motor 1. When the motor 1 is driven to rotate the gear member 2C in the anticlockwise direction C1, the reduction gear 3A meshing with the gear member 2C is driven and rotated in the clockwise direction C2. Under the condition that sets the helical directions of the helical teeth and the directions of rotation, the thrust force Th that acts in the direction toward the motor 1 (downward direction from above in FIG. 10) is generated in the reduction gear 3A. Thus, the thrust force Th can act to prevent the gear member 2C from falling off from the output shaft 12 in the axial direction.

According to the third modified embodiment, by utilizing the thrust force Th generated during rotation of the gear member 2C, the gear member 2C can be prevented from falling off from the output shaft 12 without providing any special shape configuration as shown in FIG. 8.

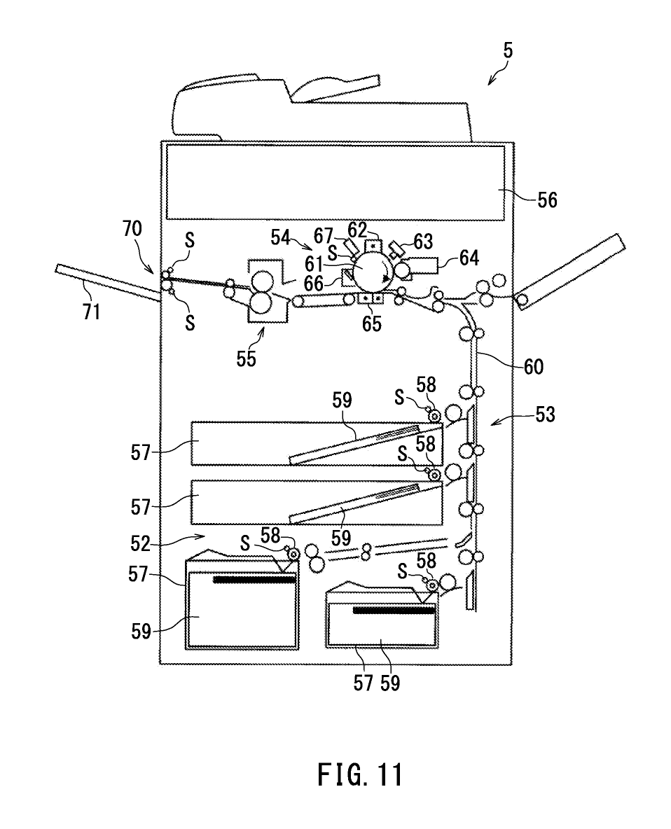

The driving apparatus S is used in an electronic device as a component for rotating a rotor. FIG. 11 is an illustration showing a schematic configuration of an image forming device including the driving apparatus S according to one embodiment of the present disclosure. The image forming device 5 includes a paper feed section 52 arranged in the lower part thereof, a paper conveyance section 53 arranged beside the paper feed section 52, an image forming section 54 arranged above the paper conveyance section 53, a fixing unit 55 arranged on the ejection side of the image forming section 54, and an image reading section 56 arranged above the image forming section 54 and the fixing unit 55.

The paper feed section 52 includes a plurality of paper feed cassettes 57 that accommodate paper 59 as a recording medium. By rotating a paper feed roller 58, the paper 59 is sent out sheet by sheet from a paper feed cassette 57 selected from the plurality of paper feed cassettes 57 to the paper conveyance section 53.

The paper 59 sent to the paper conveyance section 53 is conveyed toward the image forming section 54 through a paper conveyance path 60 provided in the paper conveyance section 53. The image forming section 54 forms a toner image onto the paper 59 by an electrophotographic process. The image forming section 54 includes a photosensitive drum 61 which is supported so as to be rotatable in the direction indicated by the arrow in FIG. 11. The image forming section 54 also includes an electrostatic charging section 62, an exposure section 63, a development section 64, a transfer section 65, a cleaning section 66, and a charge neutralizing section 67 which are arranged around the photosensitive drum 61 along the direction of rotation of the photosensitive drum 61.

The electrostatic charging section 62 includes a charging wire to which high voltage is applied. When predetermined potential is applied to the surface of photosensitive drum 61 by corona discharge from the charging wire, the surface of the photosensitive drum 61 is electrostatically charged uniformly. Then, when light based on the image data of an original document read by the image reading section 56 is irradiated to the photosensitive drum 61 by the exposure section 63, the surface potential of the photosensitive drum 61 is selectively attenuated, thereby forming an electrostatic latent image on the surface of the photosensitive drum 61.

Next, the development section 64 develops the electrostatic latent image on the surface of the photosensitive drum 61 to form a toner image on the surface of the photosensitive drum 61. The transfer section 65 transfers the toner image to the paper 59 supplied between the photosensitive drum 61 and the transfer section 65.

The paper 59 to which the toner image is transferred is conveyed toward the fixing unit 55 arranged on the downstream side in the paper conveyance direction of the image forming section 54. In the fixing unit 55, the paper 59 is heated and pressurized, thereby fusing and fixing the toner image to the paper 59. Subsequently, an ejection roller pair 70 ejects the paper 59, to which the toner image is fixed, onto an exit tray 71.

After transfer of the toner image to the paper 59 by the transfer section 65, the cleaning section 66 removes toner remaining on the surface of the photosensitive drum 61. Also, the charge neutralizing section 67 removes residual charges on the surface of the photosensitive drum 61. Subsequently, the photosensitive drum 61 is electrostatically charged again by the electrostatic charging section 62. Then, image formation is performed likewise.

The driving apparatus S in the image forming device 5 may be used for rotating any of the paper feed roller 58, the photosensitive drum 61, and the ejection roller pair 70.

What is claimed is:

1. A driving apparatus comprising:
a rotary member configured to rotate about an axis of its own; and
a gear member having an inner peripheral surface which forms a space corresponding to a shape of the rotary member and an outer peripheral surface on which gear teeth are formed, the gear member being fitted to the rotary member by press fit,
wherein the outer peripheral surface includes, in a direction of an axis of rotation of the gear member, a toothed region in which the gear teeth are formed and a non-toothed region in which no gear teeth are formed,
the inner peripheral surface includes, in the direction of the axis of rotation of the gear member, a non-press fit region with an inner diameter having a size that requires no press fitting of the gear member and a press fit region with an inner diameter having a size that requires the press fitting of the gear member, and
at least part of the non-press fit region lies within a region corresponding to the toothed region, while the press fit region lies within a region corresponding to the non-toothed region.

2. The driving apparatus of claim 1,
wherein the non-toothed region is a peripheral surface with a diameter smaller than that of a root circle of the toothed region.

3. The driving apparatus of claim 1,
wherein a length ratio between the toothed region and the non-toothed region in the direction of the axis of rotation of the gear member is in a range between 4:1 and 5:1.

4. The driving apparatus of claim 1,
wherein a ratio of a difference of an inner diameter of the gear member from an outer diameter of the rotary member to the outer diameter of the rotary member is +0.0% to +0.3% before the gear member is fitted to the rotary member, and
a ratio of the difference of the inner diameter of the gear member from the outer diameter of the rotary member to the outer diameter of the rotary member is −0.3% to −0.6%.

5. The driving apparatus of claim 1,
wherein the rotary member has a first flat surface at an end on a side where the gear member is inserted to the rotary member,
the gear member has a second flat surface at an end opposite to the end on the side where the gear member is inserted to the rotary member, and
the second flat surface is aligned with the first flat surface when the gear member is inserted properly to the rotary member.

6. The driving apparatus of claim 1, further comprising:
a motor configured to generate rotational force,
wherein the rotary member is an output shaft of the motor.

7. The driving apparatus of claim 1,
wherein the toothed region is arranged on a front end side in an insertion direction in which the gear member is inserted to the rotary member, and the non-toothed region is arranged on a rear end side in the insertion direction.

8. The driving apparatus of claim 1,
wherein the non-toothed region is arranged on each of a front end side and a rear end side in an insertion direction in which the gear member is inserted to the rotary member, and the toothed region is arranged between the non-toothed region on the front end side and the non-toothed region on the rear end side.

9. The driving apparatus of claim 1,
wherein a first engaging portion is formed at the press fit region of the inner peripheral surface, and
a second engaging portion configured to engage with the first engaging portion is formed at a peripheral surface of the rotary member.

10. The driving apparatus of claim 1,
wherein the gear member includes helical gear teeth, and
a helical direction of the helical gear teeth and a direction of rotation of the rotary member are directions where thrust force that acts to prevent the gear member from falling off from the rotary member in an axial direction is generated.

11. A gear member fitted by press fit to a rotary member rotating about an axis of its own, comprising:
an inner peripheral surface; and
an outer peripheral surface,
wherein the outer peripheral surface includes, in a direction of an axis of rotation of the gear member, a toothed region in which the gear teeth are formed and a non-toothed region in which no gear teeth are formed,
the inner peripheral surface includes, in the direction of the axis of rotation of the gear member, a non-press fit region with an inner diameter having a size that requires no press fitting of the gear member and a press fit region with an inner diameter having a size that requires the press fitting of the gear member, and
at least part of the non-press fit region lies within a region corresponding to the toothed region, while the press fit region lies within a region corresponding to the non-toothed region.

12. An electronic device comprising a driving apparatus,
wherein the driving apparatus includes:
a rotary member configured to rotate about an axis of its own; and
a gear member having an inner peripheral surface which forms a space corresponding to a shape of the rotary member and an outer peripheral surface on which gear teeth are formed, the gear member being fitted to the rotary member by press fit,
the outer peripheral surface includes, in a direction of an axis of rotation of the gear member, a toothed region in which the gear teeth are formed and a non-toothed region in which no gear teeth are formed,
the inner peripheral surface includes, in the direction of the axis of rotation of the gear member, a non-press fit region with an inner diameter having a size that requires no press fitting of the gear member and a press fit region with an inner diameter having a size that requires the press fitting of the gear member, and
at least part of the non-press fit region lies within a region corresponding to the toothed region, while the press fit region lies within a region corresponding to the non-toothed region.
